(19) United States
(12) Patent Application Publication
(10) Pub. No.: US 2025/0065809 A1
(43) Pub. Date: Feb. 27, 2025

(54) RECREATIONAL VEHICLE AND STORAGE DEVICE FOR AN INTERIOR

(71) Applicant: Thor Tech, Inc., Elkhart, IN (US)

(72) Inventors: Alexander Kasteleiner, Greifenberg (DE); Jens Kromer, Achern (DE); Olaf Sackers, Sulz (DE)

(73) Assignee: Thor Tech, Inc., Elkhart, IN (US)

(21) Appl. No.: 18/813,818

(22) Filed: Aug. 23, 2024

(30) Foreign Application Priority Data
Aug. 25, 2023 (DE) 10 2023 122 923.0

(51) Int. Cl. B60R 5/00; B60P 3/39

(52) U.S. Cl. CPC B60R 5/003; B60P 3/39

(57) ABSTRACT

A storage device for an interior of leisure vehicles, in particular of motorhomes and/or campervans and/or recreational vehicles based on a high-roof station wagon, with an at least approximately horizontally aligned storage surface. It is proposed that a first rod arrangement, which has a plurality of rods, and a second rod arrangement, which has a plurality of rods, are provided, that the rods of the first rod arrangement and the rods of the second rod arrangement are at least substantially pushed into one another in a pushed-in state to at least partially form the storage surface, and in that, in order to enlarge the storage surface in an extended state the rods of the second rod arrangement are at least partially formed from the rods of the first rod arrangement are pulled out. Furthermore, a recreational vehicle with such a storage device is indicated.

### BACKGROUND

The invention relates to a recreational vehicle, in particular a motorhome and/or a campervan. In particular, the invention relates to a vehicle based on a high roof combination recreational vehicle.

In a leisure vehicle, such as a motorhome, there are usually several approximately horizontally aligned storage surfaces. If the interior space of the leisure vehicle is particularly limited, then facilities with storage areas are not feasible or only feasible to a limited extent if storage space for bulky goods is also required.

### BRIEF SUMMARY

The object of the invention is to provide a storage device for a leisure vehicle and a Recreational vehicle, which are of improved design. In particular, it is a task of the invention to provide a storage device for a recreational vehicle and a recreational vehicle in which a relatively large storage area can be realized with a particularly limited interior space of the recreational vehicle and at the same time a storage space for the transport of bulky goods is made possible.

The problem is solved by a storage device with the features of independent patent claim 1 and by a leisure vehicle with the features of patent claim 10. Advantageous further developments of the invention are given in the subclaims.

The problem is solved by a storage device for an interior of leisure vehicles, in particular motorhomes and/or camper vans and/or leisure vehicles based on a high-roof station wagon, with an at least approximately horizontally aligned storage surface, wherein a first

A rod arrangement comprising a plurality of rods and a second rod arrangement comprising a plurality of rods, wherein the rods of the first rod arrangement and the rods of the second rod arrangement are provided in a pushed-in state for at least partially forming the depositing surface at least substantially in the first state are pushed into one another and wherein the rods of the second rod arrangement are at least partially pulled out of the rods of the first rod arrangement to enlarge the storage surface in an extended state.

Furthermore, the problem is solved by a leisure vehicle, in particular a motorhome and/or a campervan and/or a leisure vehicle based on a high-roof station wagon, with at least one such storage device.

It is advantageous that the rods of the first rod arrangement and the rods of the second rod arrangement in the inserted state, the storage surface is formed as an at least essentially gap-free storage surface. This allows the storage surface to be used to advantage in the inserted state. In particular, it is possible to place small items without them falling through gaps in the storage surface.

It is advantageous that the rods of the first rod arrangement and the rods of the second rod arrangement are arranged alternately next to each other in the inserted state. This enables advantageous guidance. Furthermore, a high level of stability can be guaranteed.

It is advantageous that the rods of the second rod arrangement can be pulled out of the rods of the first rod arrangement at least approximately parallel to the storage surface. This ensures a horizontal storage surface.

It is advantageous that at least one support element, which is preferably designed as a support board, is provided, that the support element has a width in the pull-out direction, in which the rods of the second rod arrangement can be pulled out of the rods of the first rod arrangement, which is at least is approximately equal to a width, viewed in the pull-out direction, of the support surface in the pushed-in state, and in that the support element can be enlarged, in particular unfolded, in such a way that in an enlarged, in particular unfolded, state the support element has an enlarged width, viewed in the pull-out direction, which is at least approximately equal to a width, viewed in the pull-out direction, of the support surface in the pushed-in state.

The width of the shelf in the extended state when viewed in the extension direction is. The support board can provide additional functionality. This can ensure additional use of the leisure vehicle, particularly in relation to a bed, even if the interior space is very limited.

It is advantageous that the support element is arranged vertically under the support surface and horizontally at least partially next to the support surface and/or that the support element forms a support surface in the enlarged state, on which a camping bed support, in particular one end of the camping bed support, can be supported. This means that the support surface can be camping bed pad can be extended.

It is advantageous that a preferably closed plate is provided, that the rods of the first rod arrangement are connected to the plate and that the storage surface is partially formed on the plate. The size of the plate can be adapted to different interior widths of the leisure vehicle.

It is advantageous that at least one support element, in particular a support plate, is provided for vertical support, to which the plate is at least indirectly attached at its end face. The vertical support can be realized in such a way that loading is possible from the rear in particular.

It is advantageous that at least one support element, in particular a support plate, is provided for vertical support, to which the rods of the first rod arrangement are at least indirectly attached. In this case, the vertical support can be realized in such a way that loading is possible, especially from the rear.

It is advantageous that the storage device is arranged in a rear compartment. This can improve the functionality of the leisure vehicle.

In particular, an advantageous loading, even with bulky goods, and the realization of a camping bed as well as the stowage of other, smaller goods can be made possible.

It is advantageous that an at least partially folding rear bench seat is provided.

Is that there is a storage space next to the storage unit when it is pushed in, in particular for at least one bicycle, remains free, and that the storage surface extends at least substantially across one width of the interior when extended. This means that, if necessary, it can be used to transport bulky goods even if the interior space is very limited.

Further advantages and details of the invention are described in the schematic figures.

### BRIEF DESCRIPTION OF THE SEVERAL VIEWS OF THE DRAWINGS

FIG. 1 a leisure vehicle with a storage device according to an embodiment example in a schematic, spatial representation, whereby a view from the rear with the tailgate open is shown;

FIG. 2 an excerpt from an open, partially sectioned representation of FIG. 1 from the viewing direction marked II;

FIG. 3 the leisure vehicle shown in FIG. 1, with a storage space for a bicycle created in the rear;

FIG. 4 the leisure vehicle shown in FIG. 3, with the storage space emptied to allow an enlargement of a storage area;

FIG. 5 the recreational vehicle shown in FIG. 4, with the storage area enlarged;

FIG. 6 shows the recreational vehicle shown in FIG. 5 in an excerpt-wise, opened, partially sectioned view from the direction indicated by VI;

FIG. 7 the recreational vehicle shown in FIG. 5, wherein a mattress of a camping bed designed as an air mattress for, for example, two persons who can sleep lengthwise is shown; and

FIG. 8 the recreational vehicle shown in FIG. 7 from the viewing direction shown with VIII, whereby the mattress is not shown.

### DETAILED DESCRIPTION

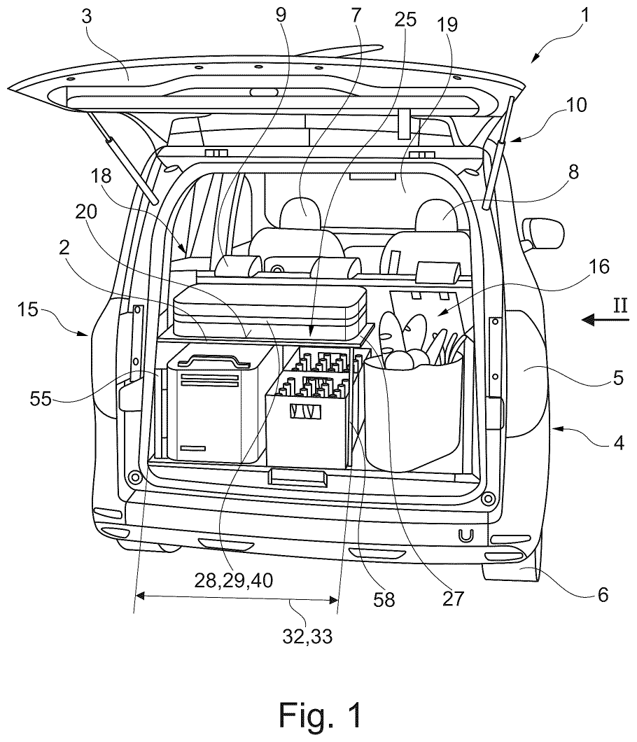

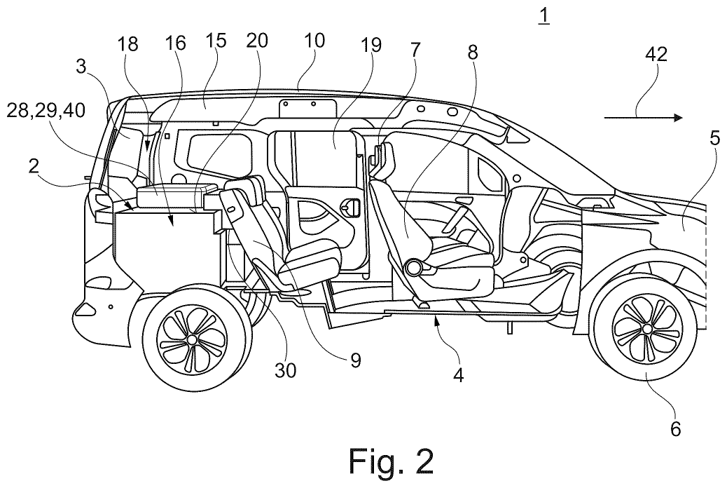

FIG. 1 shows a recreational vehicle 1 with a storage device 2 corresponding to a schematic, spatial representation of an embodiment example, showing a view from the rear with the tailgate 3 open. FIG. 2 shows an excerpted, open, partially sectioned view of the leisure vehicle 1 shown in FIG. 1 from the viewing direction marked II.

The leisure vehicle 1 can be based on a base vehicle 4. In this example, the base vehicle 4 is a high-roof station wagon. This allows the leisure vehicle 1 to be manufactured with reduced production costs. In order to optimize the manufacturing costs, the body 5, the chassis 6, the seats 7, 8 of the first row and the rear seat 9 are used in particular. The tailgate 3 is preferably the tailgate 3 of the base vehicle 4. However, suitable modifications are possible. For example, a suitable roof cut-out (not shown) can be provided on the roof 10, for example to allow access to a roof tent.

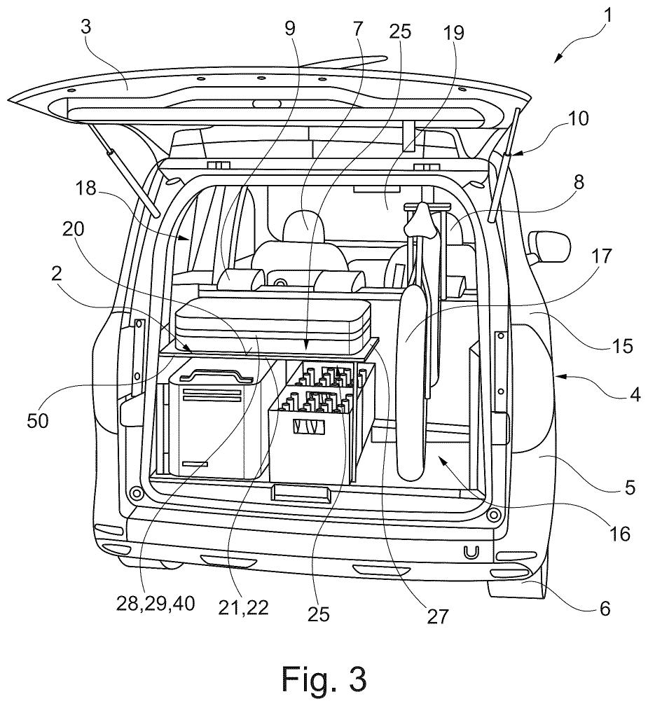

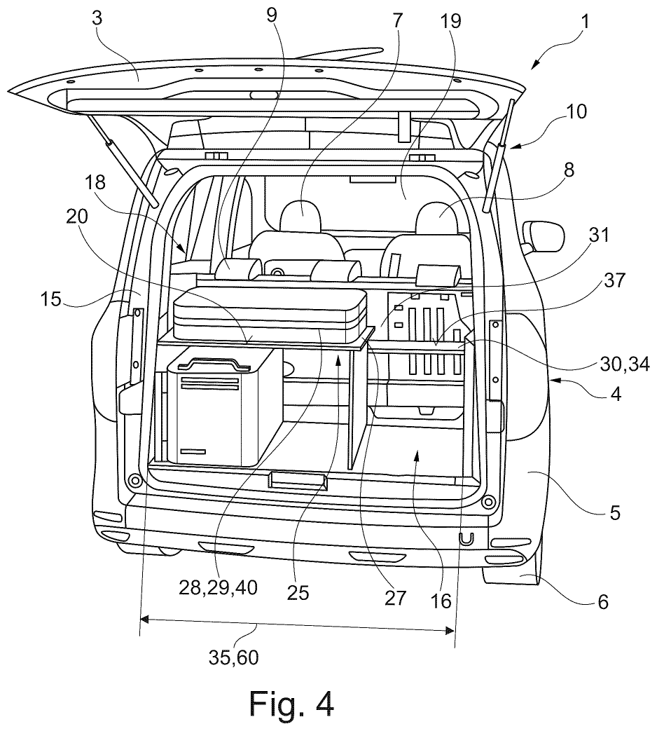

In the following, the recreational vehicle 1 and the storage device 2 are also described further with reference to FIGS. 3 to 5. FIG. 3 shows the leisure vehicle 1 shown in FIG. 1, with a storage space in the rear 15. 16 is created for a bicycle 17. FIG. 4 shows the leisure vehicle 1 shown in FIG. 3, with the storage space 16 emptied, so that an enlargement of a storage surface 20 of the storage device 2 is possible. In this embodiment example, the storage space 16 or the bicycle 17 is partially realized or can be arranged in a rear compartment 18 in the rear 15 of the base vehicle 4.

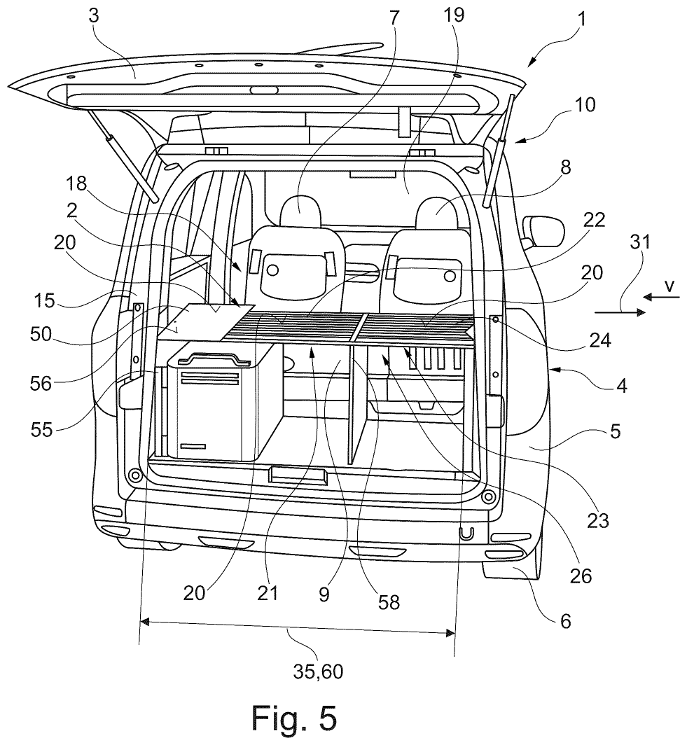

FIG. 5 shows the leisure vehicle 1 shown in FIG. 4, whereby the storage area 20 is enlarged. The recreational vehicle 1 has a storage device 2. However, the storage device 2 can also be manufactured and sold independently of a recreational vehicle 1.

The storage device 2 is used for an interior 19 of the leisure vehicle 1. In this embodiment example, the base vehicle 4 is a high-roof estate 4, which only has a limited interior 19. The storage device is arranged in the rear compartment 18. In addition, exactly one storage device 2 is provided, which is not necessary in the limited interior 19 is preferred. However, the storage device 2 is also suitable for larger motorhomes and/or camper vans, whereby two or more storage devices 2 can also be provided if necessary.

The storage device 2 has a horizontally aligned storage surface 20. Furthermore, the storage device 2 comprises a first rod arrangement 21, which has a plurality of rods 22, and a second rod arrangement 23, which has a plurality of rods 24. The rods 22 of the first rod arrangement 21 and the rods 24 of the second rod arrangement 23 partially form the storage surface in a pushed-in state 25, in which the rods 22, 24 are pushed into one another in opposite directions.

To simplify the illustration, only one bar 22, 24 is marked in FIG. 5. In this embodiment example, the rods 22 of the first rod arrangement 21 and the rods 24 of the second rod arrangement 23, when inserted, forms a gap-free storage surface 20. The rods 22 of the first rod arrangement 21 and the rods 24 of the second rod arrangement 23 are arranged alternately next to each other in the inserted state.

The rods 24 of the second rod arrangement 23 can be moved by a user parallel to the storage surface 20 can be pulled out of the rods 22 of the first rod arrangement 21. In an extended state 26, the storage surface 20 is then enlarged. The rods 24 of the second rod arrangement 23 are then essentially pulled out of the rods 22 of the first rod arrangement 21. The user can pull out the second rod arrangement 23 by a handle 27, for example, and then pull it out again slide in.

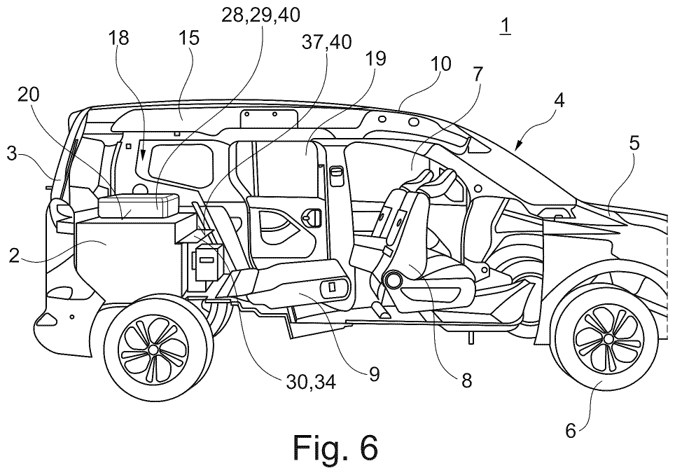

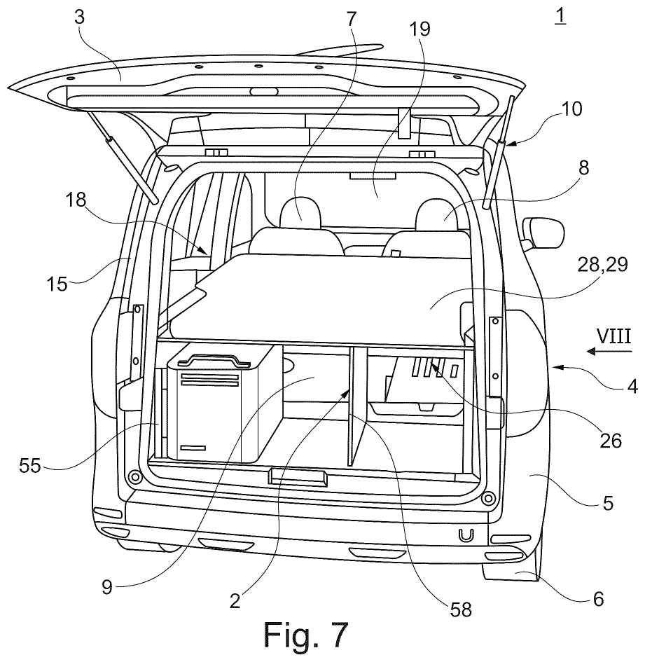

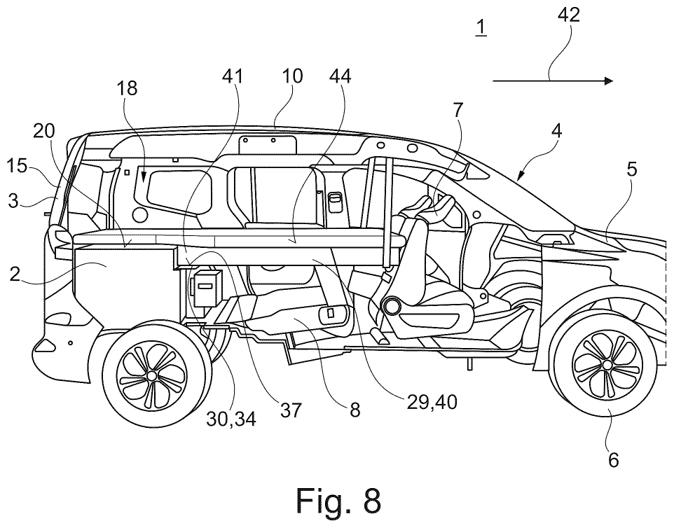

In the following, the embodiment of the embodiment example is also described further with reference to FIGS. 6 to 8. FIG. 6 shows the recreational vehicle 1 shown in FIG. 5 in an excerpted, opened, partially sectioned view from the viewing direction designated VI. FIG. 7 shows the recreational vehicle 1 shown in FIG. 5, with a mattress 28 of a camping bed 29 designed as an air mattress 28 for e.g. two people who can sleep lengthwise is shown. FIG. 8 shows the leisure vehicle 1 shown in FIG. 7 from the viewing direction shown with VIII, whereby the mattress 28 is not shown.

The storage device has a support element 30, which is designed as a hinged support board 30 is designed. The support element 30 has a width 32 in the folded (collapsed) state when viewed in the pull-out direction 31, in which the rods 24 of the second rod arrangement 23 can be pulled out of the rods 22 of the first rod arrangement 21. The width 32 is equal to the width 33 of the storage surface 20, also viewed in the extension direction 31, in the retracted state 25 of the Storage area 20.

The support element 30 can be enlarged by folding it open. In the unfolded state 34, the support element 30 has an increased width 35 viewed in the pull-out direction 31, which is equal to a width 33 of the support element 30 viewed in the pull-out direction 31. Shelf 20 is in the extended state 26.

Viewed vertically, the support element 30 is arranged under the storage surface 20. Furthermore, the support element 30 is arranged next to the storage surface 20 when viewed horizontally. In the enlarged state 34, the support element 30 forms a support surface 37, on which a camping bed support 40 for the camping board 29 is supported. Here, one end 41 of the camping bed support 40 is placed on the support surface 27 in such a way that the camping bed support 40 extends the support surface 20 in the longitudinal direction 42 of the vehicle 1. Preferably, the support surface 20 is extended continuously by the upper side 44 of the camping bed support 40. The air mattress 28 can then be placed on the storage surface 20 and the top 44 of the camping bed pad 40.

In addition, a preferably closed plate 50 is provided. The rods 22 of the first rod arrangement 21 are connected to the plate 50. The storage surface 20 is in also partially formed on the plate 50 in this embodiment example. For vertical a support element 55, which is designed as a support plate 55, is also provided for support. The plate 50 is attached to the support plate 55 at its end face 56. In addition, a support element 58, which is designed as a support plate 58, is provided for vertical support. The rods 22 of the first rod arrangement 21 attached.

The leisure vehicle 1 has a rear seat 9 that can be folded down in several parts (segments). In the retracted state, a storage space 16 can be created next to the storage device 2, which can be used for at least one bicycle 17 or other bulky items.

Goods is sufficient. On the other hand, when extended, the storage surface 20 extends at least substantially over a width 60 of the interior 19 in the rear 15, i.e. the rear compartment 18.

The invention is not limited to the embodiments described.

What is claimed is:

1. A storage device for an interior of leisure vehicles, in particular of motor homes and/or camper vans and/or leisure vehicles based on a high-roof station wagon, having at least an approximately horizontally aligned storage surface, wherein:
a first rod arrangement, which has a plurality of rods, and a second rod arrangement, which has a plurality of rods, are provided, in that the rods of the first rod arrangement and the rods of the second rod arrangement are arranged in such a way that the rods of the first rod arrangement and the rods of the second rod arrangement are at least substantially pushed into one another in a pushed-in state to at least partially form the storage surface; and
to enlarge the storage surface in an extended state, the rods of the second rod arrangement are at least partially pushed out of the rods of the first rod arrangement, wherein the rods of the second rod arrangement are at least partially pushed into one another to at least partially form the storage surface are pulled out.

2. The storage device according to claim 1, wherein the rods of the first rod arrangement and the rods of the second rod arrangement in the inserted state the storage surface as an at least essentially gap-free storage surface.

3. The storage device according to claim 1, wherein the rods of the first rod arrangement and the rods of the second rod arrangement are arranged alternately next to each other in the inserted state.

4. The storage device according to claim 1, wherein the rods of the second rod arrangement are at least approximately parallel to the support surface of the rods of the first rod arrangement can be pulled out.

5. The storage device according to claim 1, wherein:
at least one support element, which is preferably a support board the support element has a width in the extension direction, in which the rods of the second rod arrangement can be pulled out of the rods of the first rod arrangement, which is at least approximately equal to a width, viewed in the extension direction, of the support surface in the pushed-in state; and
the support element can be enlarged, in particular folded open, such that the support element in an enlarged, in particular unfolded, state has an enlarged width, viewed in the pull-out direction, which is at least approximately equal to a width, viewed in the pull-out direction, of the support surface in the unfolded state is in the extended state.

6. The storage device according to claim 5, wherein the support element, viewed vertically, is below the support surface and is arranged at least partially next to the support surface when viewed horizontally and/or that the support element forms a support surface in the enlarged state, on which a camping bed support, in particular one end of the camping bed support, can be supported.

7. The storage device according to claim 1, wherein a preferably closed plate is provided, that the rods of the first rod arrangement are connected to the plate and that the support surface is partially formed on the plate.

8. Storage device according to claim 7, wherein at least one supporting element, in particular a supporting plate, is provided for vertical support, on which the plate is mounted at its end face is at least indirectly attached.

9. Storage device according to claim 1, wherein for vertical support at least one supporting element, in particular a support plate is provided, to which the rods of the first rod arrangement are at least indirectly fastened.

10. A recreational vehicle, in particular motorhome and/or campervan and/or recreational vehicle based on a high-roof estate, having the storage device according to claim 1.

11. Recreational vehicle according to claim 10, wherein the storage device is arranged in a rear compartment.

12. The recreational vehicle according to claim 10, wherein an at least partially folding rear seat is provided, that in the retracted state a storage space is provided next to the storage device, in particular for at least one bicycle, remains free, and that the storage surface extends at least substantially across one width of the interior when extended.
